(19) United States
(12) Patent Application Publication
(10) Pub. No.: US 2003/0016774 A1
(43) Pub. Date: Jan. 23, 2003

(54) Method and apparatus for stimulated beta decays

(76) Inventor: Rugerro Maria Santilli, Palm Harbor, FL (US)

Correspondence Address: MASON & ASSOCIATES, PA, 17757 US HWY 19 N., SUITE 500, CLEARWATER, FL, 33764, US

(21) Appl. No.: 10/246,589

(22) Filed: Sep. 18, 2002

Related U.S. Application Data
(62) Division of application No. 09/378,860, filed on Aug. 23, 1999.

(51) Int. Cl. G21G 1/00

(52) U.S. Cl. 376/156

(57) ABSTRACT

A method for the synthesis of neutrons from protons and electrons comprising apparatus for said protons and electrons to have a threshold relative energy of about 0.80 MeV, for said protons and electrons to be in anti-parallel coupling, and for forcing said protons and electrons in anti-parallel coupling to be at a mutual distance essentially of one Fermi. Another embodiment includes a method for the stimulated decay of a peripheral neutron in a nucleus. Another embodiment includes apparatus for the stimulated beta decay of a natural isotope into another natural isotope, the latter having the same number of nucleons of the former and one additional proton, wherein the conservation of total energy, angular momentum and parity are satisfied. Another embodiment includes apparatus for the stimulated beta decay of radioactive waste.

### RELATED APPLICATION

This patent application is a divisional application of U.S. patent application Ser. No. 09/378,860 filed on Aug. 23, 1999, the latter containing no classified material.

### FIELD OF THE INVENTION

This application relates to a method for the synthesis of neutrons from protons and electrons, and a method for the stimulated decay of a peripheral neutron in a nucleus and its related apparatus.

### BACKGROUND OF THE INVENTION

The only known to the inventor herein prior art related to a process of accelerated beta decay is disclosed in U.S. Pat. No. 4,961,880 entitled “Electrostatic Voltage Excitation Process and Apparatus” to William A. Barker.

This patent only discloses accelerated alpha decay of an isotope through an applied high voltage potential to the isotope to be accelerated in alpha decay. The patent mentions a possible application of an accelerated beta decay but makes no claims to such and does not use a method relating to the subject of this patent. This prior art patent uses a high voltage potential to deform the columb barrier to allow for accelerated alpha decay and makes no claim to stimulate a beta decay by acting on individual neutrons as does the present invention.

As it is well known, when isolated in vacuum, the neutron (hereinafter indicated with the symbol “n”) is an unstable particle with a mean life of about 916 seconds, which decay into the proton (hereinafter denoted with the symbol “p”) the electron (denoted with the symbol “e”) and the antineutrino (denoted with the symbol “v′”), according to the known reaction n->p+e+v′.

Moreover, neutrons are synthesized in the interior of stars from protons and electrons according to the equally well known reaction p+e->n+v (where “v” represents a neutrino). In fact, stars begin their lives by being solely composed of hydrogen, namely, of protons and electrons. Then stars synthesize in their interior neutrons, then deuterons, and then all known nuclei. As a matter of fact, Rutherford originally conceived the neutron in 1920 precisely as a “compressed hydrogen atom in the core of a star,” namely, as an electron compressed inside a proton, hereon called “Rutherford's electron”.

Since neutrons are naturally unstable and they are synthesized from protons and electrons, they must admit at least one form of stimulated decay. This invention presents a method and an apparatus for the stimulated decay of the neutron via resonance means (hereon symbolically represented with the symbol “m” which, when acting on the neutron, are absorbed by the electron by exciting and causing the stimulated reaction in vacuum

m+n->p+e+v′ Eq. (1)

at the time of application of the resonating means “m”, thus in less then the naturally occurring 916 seconds.

In particular, the resonating means “m” are selected to apply also when the neutron is a member of a selected class of nuclei, thus resulting in a process here called “stimulated beta decay of natural isotopes” which can be defined via the nuclear reaction

m+N(A, Z)->N(A, Z+1)+e+v′ Eq. (2)

where A is the total number of protons and neutrons (collectively called nucleons) and Z is the total number of protons.

The class of nuclei admitting stimulated beta decay (2) is rather restricted in as much as the stimulated reaction must verify all known nuclear laws, including the conservation of energy, angular momentum, parity, and other laws. Despite all these restrictions, an important discovery of this invention is that nuclei verifying all needed physical laws do indeed exist and will be identified in detail below.

It should be stressed that, when the neutron is a member of a suitably selected nucleus, there exist additional means to stimulate its beta decay besides that treated in this invention, which means evidently based on the action over the entire nuclear structure, rather than on individual neutrons as per this invention. In particular, new actions on the nuclear force can indeed produce stimulated beta decays because the nuclear force is ultimately responsible for the great variety of neutron meanlives from one nucleus to another, ranging from microseconds to full stability. The latter collective methods and related apparata are not treated in this invention because they constitute a separate species.

This patent application is organized as follow. First, we shall review the basic characteristics of neutrons, protons and electrons and identify their compatibilities or lack thereof; then we shall identify the general physical laws necessary for the synthesis of protons and electrons into neutrons since such a synthesis is at the foundation of said stimulated decay; finally we shall identify in construction details a preferred embodiment of this invention which implements and optimizes the stimulated decay of neutrons based on the excitation of their Rutherford's electrons.

The main characteristics of the neutron (as available from the known Particle Data Group) are: (1) rest energy 939.565 Million electron Volts (MeV); (2) charge 0; (3) spin h/2?, where h is Planck's constant (hereon referred to as spin ½ in units of h/? as customary in contemporary physics); (4) magnetic dipole moment −1.91 μN; (5) electric dipole moment essentially null; (6) charge radius of about one Fermi (=10⁻³ cm); and (7) the particle is unstable with meanlife of 916 seconds (when isolated in vacuum) and spontaneous decay n->p+e+v′, where v′ is an antineutrino.

The main feature of the proton are: (1) rest energy 938.272 MeV; (2) charge +e; (3) spin ½; (4) magnetic dipole moment 2.79 μN; (5) electric dipole moment essentially null; (6) charge radius of about one Fermi; and (7) the particle is stable.

The main feature of the electron are: (1) rest energy of 0.511 MeV; (2) charge −e; (3) spin ½; (4) magnetic dipole moment 1.00 μB; (5) electric dipole moment essentially null; (6) charge radius essentially null; and (7) the particle is stable.

As indicated earlier, the synthesis of the neutron from a proton and an electron is the necessary foundation for its stimulated decay. Therefore, we shall now study the compatibility or lack thereof of the above characteristics for the indicated synthesis. The related main aspects can be summarized as follows:

(I) The rest energy of the neutron (939.565 MeV) is greater than the sum of the rest energies of the proton (938.272 MeV) and of the electron (0.511 MeV). This behavior is the opposite of the general rule in nuclear physics whereby the sum of the rest energies of given nuclear constituents is bigger than that of the final nuclear state, thus implying the customary “negative binding energy” with resulting well known “nuclear mass defect” which “produces” heat and other forms of energy. By comparison, the synthesis of one neutron from one proton and one electron “requires” energy in the amount

[939.565−(938.272+0.511)] MeV=0.782 MeV. Eq. (3)

It should be noted that a bound state of two particles at short distance, the proton and the electron, whose total rest energy is bigger than the sum of the rest energies of the constituents, is prohibited by quantum mechanics because it would require a “positive binding energy,” namely, a form of binding incompatible with the basic laws of quantum mechanics.

Because of this feature, by keeping in mind the plausibility of Rutherford's original conception of the neutron, a generalization of quantum mechanics under the name of “hadronic mechanics” was proposed by this inventor in 1978 when he was a member of Harvard University under support by the U.S. Department of Energy. Thanks to the use of generalized mathematics based on arbitrary units (rather than the traditional unit+1) and thanks to contributions by a large number of scholars, hadronic mechanics was built in the past decades by permitting the resolution of the above bound state problem, while achieving an “invariant” and “exact” representation of “all” characteristics of the neutron as a bound state of one proton and one electron in condition of mutual penetration at mutual distance of the order of the proton charge radius (one Fermi=10⁻¹³ cm).

These results were first reached by R. M. Santilli in the scientific publications: “Apparent consistency of Rutherford's hypothesis of the neutron as a compressed hydrogen atom,” published in Hadronic Journal Vol. 13, page 513 (1990): “Recent theoretical and experimental evidence on the fusion of elementary particles,” publication of the Joint Institute for Nuclear Research, Dubna, Russia, #E4-93-252 (1993); “Recent Theoretical and experimental evidence on the apparent synthesis of the neutron from protons and electrons,” published in the Chinese Journal of System Engineering and Electronics Vol. 6, page 177 (1995); and in subsequent papers.

This invention is based on the observation that, when the electron is “compressed” (in Rutherford's language) inside the proton, it must necessarily acquire an orbital motion illustrated in FIG. 1. This is due to the fact that the proton is an extended particle with spin, while the electron has a point-like charge structure and is about 2,000 times lighter than the proton. Therefore, the initiation of Rutherford's compression of the electron inside the hyperdense medium within a proton can only occur if the proton carries the electron in its angular motion. It is evident that, during its orbital motion within the proton structure, the electron acquires the excess energy of 0.782 MeV, resulting in the total energy of 1.294 MeV.

In summary, the above simplistic kinematic model is sufficient for this invention, without any need of entering into complex theoretical representations of the bound state itself, the latter being unstable anyhow. Nevertheless, it should be indicated that refinements of the stimulated beta decay presented in this Patent Application will mandate the use of the covering hadronic mechanics for the bound state of particles when in conditions of total mutual penetration.

(II) As recalled above, the neutron, the proton and the electron all have spins. The feature addressed herein is the property well known in classical and quantum mechanics according to which collisions of two particles with parallel spins (also called “triplet coupling”) cause repulsive forces. Therefore, a necessary condition for the synthesis of the neutron from a proton and an electron is that the latter should be coupled with anti-parallel spins (also called “singlet coupling”). Another basic feature of this invention is the restriction of the synthesis of neutrons only to protons and electrons in anti-parallel coupling in a planar configuration as illustrated in FIG. 1. This feature is evidently important for mechanisms intended to stimulate the expulsion of the electron from the proton structure a discussed below.

(III) The proton, the electron and the neutron all have spin ½. According to current academic trends, the synthesis of the neutron cannot occur under the conservation of the angular momentum unless a massless particle with spin ½, known as the neutrino v, is assumed to be emitted according to the reaction p+e->n+v. Nevertheless, the hypothesis of the neutrino remains controversial for various reasons, such as: large laboratories have been built (such as that inside the mountain Gran Sasso in Italy) and operated for years with large expenditures without any appreciable detection of neutrinos; to be compatible with experimental evidence, the entire Earth should be transparent to neutrinos, which is against any rational thinking; and other problems.

It should be noted that the neutrino hypothesis is a consequence of belief in contemporary academic trends that the electron is emitted radially in the neutron decay. In reality, when the electron is trapped inside the proton, it must assume an orbital motion, as indicated earlier. In particular, such an orbital angular momentum (se−orb) can account for the spin of the neutron spin (sn) without any need of the hypothesis of the neutrino, according to the expression

sn=½=sp−se+se−orb=½−½+se−orb, se−orb=½. Eq. (4)

The latter value is fully plausible because when trapped inside the hyperdense medium within the proton, the angular motion of the electron must evidently coincide with the spin of the much heavier proton (see FIG. 1 and the above quoted papers).

It should be indicated that the value ½ for the orbital angular momentum is prohibited by quantum mechanics (because it violates the unitarity condition), although it is fully admitted by the broader hadronic mechanics precisely thanks to the broader mathematics based on generalized units (in which case the angular momentum ½ verifies the isounitarity law). This patent application is filed by admitting the hypothesis of the neutrino despite the indicated unresolved controversies, and despite the availability of an alternative solution without the neutrino hypothesis, because the issue whether the neutrino exists or not is inconsequential for a first construction of the apparatus producing the stimulated beta decay. Nevertheless, it should be indicated that deeper research and development on stimulated beta decays will indeed require the direct addressing of the issue whether or not the neutrino exists.

(IV) The magnetic moment of the neutron, −1.91 μN, is not representable via the difference between the magnetic moments of the proton, 2.79 μN, and that of the electron, 1.00 μB, said difference occurring both in sign and in magnitude. Yet another basic feature of this invention is to show that the simplistic kinematic model of FIG. 1 permits an exact representation of the magnetic moment of the neutron in the indicated synthesis.

In fact, the magnetic moment of the neutron is not given by the difference of the magnetic moments of the constituents, as currently assumed in academia, but it is given instead by the superposition of three values, the magnetic moment of the proton (μp) that of the electron (μe) and the magnetic moment caused by the orbital motion of the electron within the proton (μe−orb), thus yielding the exact representation

μN=−1.91 μN=μp−μe−μe−orb=2.79 μP−1.00 μe−μe−orb, μe−orb=1,834.6 μp=1.835 μe, Eq. (5)

where the units are μN=e/2 mnc, μP=e/2 mpc, μe=e/2 mec, and e is the elementary charge in absolute (positive) value. The value μe−orb=1,834.6 μp=1.835 μe can also be independently verified to be correct in first approximation by considering the rotation of the charge −e in an orbit of radius 10⁻¹³ cm.

Note that the above exact representation of the magnetic moment of the neutron is a direct confirmation of that for the spin, Eq. (4). Both exact representations then confirm the lack of necessity to conjecture the emission of the hypothetical and controversial neutrino.

It should be stressed that the exact representation of the magnetic moment of the neutron in its synthesis from a proton and an electron is extremely complex in as much as it requires calculations based on the novel hadronic mechanics and its underlying new mathematics. These advanced studies are not reported here because they are inessential for a first derivation and construction of the apparatus for the stimulated beta decay, although these advanced studies will eventually emerge as necessary for subsequent improvements.

(V) It is generally believed that the fusion of particles requires very high temperatures and pressures. This is indeed the case for the failed attempts to achieve the controlled fusion because nuclei have the same charge, thus repelling each other. The situation for the case of protons and electrons in anti-parallel couplings is dramatically different, as illustrated in FIG. 2, because in this case the particles experience three separate “attractive” forces, namely, the attractive force between opposite charges, and the two attractive forces between the two pairs of opposing magnetic polarities.

Under these conditions, it is sufficient to avoid the creation of a hydrogen atom for a proton and an electron to naturally attract each other all the way to mutual distances of one Fermi=10⁻¹³ cm, although this is possible only when in anti-parallel coupling. It is easy to see that the latter conditions are indeed met when an electron approaches a proton in anti-parallel alignment and with the energy of 0.782 MeV, since the latter is dramatically bigger than the kinetic energy of atomic orbits (which are notoriously measured in eV). Despite these favorable conditions, it is easy to predict that additional means are needed in practice to prevent the formation of hydrogen atoms and permit the approaching of electron to protons all the way to conditions of mutual penetration, under which the synthesis has occurred.

The remaining characteristics of neutrons, protons and electrons are compatible with each other for the synthesis herein considered. For instance, the charge and electric dipole moments are conserved in the considered neutron synthesis. Also, the proton and the neutron have approximately the same charge radius while the electron is essentially dimensionless in its charge structure, thus implying compatibility of the charge radii. Similarly, the unstable character of the neutron is compatible with the full stability of the proton and the electron, since the electron has the evident tendency to exit the structure of the proton due to the centripetal force and other reasons indicated below. Nevertheless, it should be indicated that the exact numerical representation of the charge distribution of the neutron, its meanlife and other characteristics has been solely achieved via the covering hadronic mechanics, while being notoriously impossible with conventional quantum mechanics.

It should be finally noted that the above model of the synthesis of the neutrons is compatible with current quark theories. In fact, a primary function of theories based on quark hypotheses is that of studying the classification of hadrons into families, while we are here considering the synthesis of the neutron as it occurs in nature from physical particles. At any rate, it should be recalled that protons and electrons are permanently stable particles. Therefore, the claim implied by quark theories that the physical proton and the physical electron literally “disappear” at the time of the synthesis of the neutron to be replaced by the hypothetical and undetectable quarks, has no credibility.

Besides the evidence that stars synthesize neutrons from protons and electrons, the only direct verification of such a synthesis known to this inventor is that conducted in Brazil by the experimentalists C. Borghi, C. Giori and A. Dall'Olio according to the paper “Experimental evidence on the emission of neutrons from cold hydrogen plasma,” published in the (Russian) Journal of Nuclear Physics Vol. 56, p. 147 (1993).

In essence, these experimentalists filled up the interior of a cylindrical metal chamber (called klystron) with a gas of ionized hydrogen (namely, free protons and electrons) originating from the electrolytical separation of the water, and kept the gas mostly ionized via an electric discharge. Since protons and electrons are charged, they could not escape from the metal chamber and where contained in its interior.

In the outside of the chamber, the experimenters put a variety of fissionable and non-fissionable materials listed in FIG. 3A. After an exposure for periods of time ranging from days to weeks, the experimentalists detected transmutations in said exterior material with decay mode illustrated in FIG. 3B, which transmutations can only be caused by a flux of neutrons. In the absence of any other source, said neutrons can only originate from the synthesis of neutrons inside the klystron. Since the neutrons are neutral, once created inside the klystron, they can easily pass through its metal walls and escape to the outside, thus causing the detected nuclear transmutations.

Needless to say, the results of the above experiment cannot be considered as final because, as well known in science, new discoveries should be subjected to at least two additional independent verifications. The above experimental verification of the neutron synthesis has been quoted in this invention because experimental evidence can only be dismissed via counter-experiments and absolutely it cannot be dismissed in a credible way based merely on personal opinions or beliefs.

After having identified the mechanism of the synthesis of the neutron from the proton and the electron, our next step is the identification of its spontaneous decay. It is easy to see that, since the electron is subjected to centrifugal force, and in view of Heisenberg uncertainty principle and other physical laws, Rutherford's electron cannot remain permanently trapped inside a proton. The visualization of the mechanism of expulsion presented in FIG. 4A, even though approximate, provides an invaluable conceptual guide for this invention.

Inspection of FIG. 4A first reveals that the electron cannot be expelled radially, as assumed in current academic trends, but can only be released tangentially in view of its angular momentum when within the proton. FIG. 4A also reveals that, when considering a neutron in vacuum, the electron is expelled precisely with the kinetic energy of 0.872 needed for the neutron synthesis. Third, FIG. 4A confirms the lack of need for the neutrino hypothesis to explain the decay of the neutron, because the original angular momentum ½ of the electron is transformed into kinetic energy, a transformation fully compatible with classical and quantum laws, as illustrated by a rotating mass when its holding arm is released.

When the neutron is a member of a nuclear structure, thus being bound to other nucleons, the situation is different than that for the neutron in vacuum on various grounds. In fact, particle exchanges are routine processes in particle physics which are applicable to all particles, thus beginning with the electron. A first possibility is that protons exchange Rutherford's electrons among themselves, resulting in no emission of electron at all. This case is evidently that of full nuclear stability. A point fundamental for this invention is that the stability of a nucleus, by no means, implies the stability of each individual neutron, again, in view of the nuclear exchange forces. At any rate, an important component of the nuclear forces is given by the exchange forces, which are based precisely on the mechanism under consideration here. This feature evidently implies the possibility of stimulating beta decays also in stable nuclei, evidently under numerous conditions identified in detail below.

The next possibility is that when a nucleus is unstable and admits spontaneous beta decay. In this case too, the electron must be expelled tangentially from one specific neutron, rather than somewhat vaguely from the nuclear structure, as illustrated in FIG. 4B. It is then evident that the angle of ejection of the electron varies within at least 90 degrees. But the electron has a negative charge −e, while the nucleus as a positive charge +Ze. It then follows that the nucleus attracts the electron in different ways depending on the angle of expulsion. This accounts for the fact that the energy of the electrons in spontaneous nuclear beta decays does not have a constant value. The energy not acquired by the electron is acquired by the nucleus in one of its various forms of excitations, such as Coulomb excitation, deformation, etc.

At any rate, the maximal energy of electrons originating from nuclear beta decays is not 1.294 MeV, and it is instead of several MeV, as illustrated with specific examples below. This is due to the fact that in the beta transmutation N(A, Z)->N(A, Z+1)+e−+v′ the original nucleus is at an energy level bigger than the final nucleus, thus implying the emission of such energy difference during the beta decay itself.

In summary, the neutrino hypothesis is not necessary for the conservation of energy, angular momentum and other laws, not only for the synthesis of the neutron from one proton and one electron, but also for the neutron spontaneous decay, as well as for the variable character of the energy of electrons emitted in nuclear beta decays. In reality, the hypothesis of the neutrino has prevented an exact representation of the characteristics of the neutron. Even assuming quark conjectures, the spin, magnetic moment, mean life, charge radius and other characteristics of the neutron have not been represented exactly until now after decades of attempts, as one can see in contemporary controversies in particle physics (see, e.g., the so-called “spin crisis” of quark theories not reviewed in this disclosure because inessential for its content).

On the contrary, the replacement of the neutrino hypothesis with an orbital; motion of Rutherford's electron when trapped inside the proton, and its treatment via appropriate mathematical and physical theories does indeed permit an “exact, numerical and invariant” representation of “all” characteristics of the neutron.

Again, the issue as to whether the neutrino exists or not is not essential for a first enablement of this invention, although it becomes of basic relevance for subsequent developments. Consequently, the issue will be ignored hereon, and the products of the beta decay will be hereinafter denoted with the generic symbol b− to represent the emission of an electron of beta decay origin, or with the symbol b+ to represent a positron of beta decay origin (these particles will also be called “beta electron” and “beta positron” to identify the physical origin of the particle).

After having identified the synthesis of the neutron from protons and electrons and its spontaneous decay, we are now sufficiently equipped to present the main objective of this invention, the stimulated decay of the neutron whether isolated or a member of a nuclear structure.

Recall that the electron cannot remain permanently trapped inside the proton for various physical reasons indicated earlier. Therefore, there must exist a mechanism, which stimulates its expulsion, thus reducing the neutron's meanlife from its natural value of 916 seconds to an essentially null value, the decay occurring at the time of its stimulation.

Among various conceivable alternatives, the mechanism used in this disclosure to stimulate the decay of the neutron is that based on resonance effects, since the latter are known to excite or otherwise devastate classical as well as nuclear structures when properly implemented.

Among all possible means for a practical implementation of resonating effects, the most logical is the excitation of the electron trapped inside the proton via a photon with a particular resonating frequency or, equivalently, energy. In fact, the photon has no charge and traveling at the speed of light. Therefore, hard photons (that is, photons with energy of the order of MeV) can easily penetrate the electron cloud surrounding all nuclei, and then hit individual nucleons where where they are absorbed.

Recall again the crucial property that the trapping of the electron inside the proton is unstable. Therefore, known physical laws imply that the excitation of the same electron stimulates its expulsion at the very time of the excitation itself. The aspect crucial for all resonating effects is the sharpness of the value of the excitation energy. In fact, no excitation is evidently possible for insufficient energies, thus implying no stimulated beta decay. Similarly, when the supplied energy is much greater than the exact resonating value, said energy generally excites the entire nucleus or it is dispersed in other means, thus preventing again its absorption by one individual electron trapped inside one individual proton.

A basic feature of this disclosure is then the explicit value of the resonating frequency (or energy) required for each individual application. It is easy to see that, for the case of an isolated neutron in vacuum, the most effective resonating energy is the total energy of the electron, which we have identified before to be of 1.294 MeV. By introducing the symbol fn to denote the photon with sharp resonating energy (or resonating photon) for the neutron in vacuum, we therefore have the expressions

fn=1,294 MeV (or 3.129×1020 Hz), Eq. (6a)

fn=n×1.294 MeV or 1.294 MeV/n, n=1, 2, 3, 4, . . . Eq. (6b)

fn=1,294 MeV, 0.647 MeV, 0.431 MeV, 0.324 MeV, . . . Eq. (6c)

fn=1.294 MeV, 2.588 MeV, 3.870 MeV, 5,176, . . . Eq. (6d)

where Eq. (6a) represents the optimal value, Eq. (6b) represents the harmonics typical of all resonating effects, and Eq. (6c) represents the subharmonics whose values are the most important for practical applications. Needless to say, the efficiency of the stimulated neutron decay in vacuum decreases with the decrease of the subharmonic, as well known. Nevertheless, the selection of which subharmonic is suitable for the needed efficiency (here defined as the rate of stimulated decay for given resonating photons) is a practical issue depending on the specific application at hand which, as such, is left to the user of this invention.

When a neutron is a member of a nuclear structure, the situation is different because of the negative binding energy or, equivalently, the nuclear mass defect. The latter can be assumed in first approximation to be equally distributed among all nucleons (collectively represented by the symbol A, the symbol Z representing the number of protons), thus permitting a precise numerical identification of the resonating energy (also equivalently called excitation energy) per each nucleus. Consider a nucleus N(A, Z) and suppose that its binding energy is −B. The needed excitation frequency for its stimulated decay of one of its peripheral neutrons is then given by

fnucl=1.294−(B/A)(me/mp) MeV, Eq. (7)

with harmonics

fnucl=n×[1.294−(B/A)(me/mp)] MeV or fnucl=[1.294−(B/A)(me/mp)] MeV)/n, n=1, 2, 3, 4, . . . Eq. (8a)

fnucl=[1.294−(B/A)(me/mp)] MeV, [0.431−(B/2A)(me/mp)] MeV, [0.324−(B/3A)(me/mp)] MeV, . . . Eq. (8b)

fnucl=(B/A)(me/mp)] MeV, [2.588−2(B/A)(me/mp)] MeV, [3.882−3(B/A)(me/mp)]) MeV, . . . Eq. (8c)

where (B/A)(me/mp) represents the amount of binding energy per nucleon actually affecting Rutherford's electron and, again, the most important values are the subharmonics of Eq. (8b). An alternative resonating energy is the value 0.511 MeV, which is the conventional resonating energy for an electron when isolated and at rest. We reach in this way the primary stimulated nuclear beta decay of this invention

fnucl+N(A, Z)->N(A, Z+1)+b−, Eq. (9)

which evidently represents the stimulated beta decay of nucleus N(A, Z) into the nucleus N(A, Z+1) plus the emission of a very energetic electron b− generally of the order of various MeV as compared to the resonating energy of the photon which is of the order of one MeV.

It should be indicated at this point that basic reaction (9) is solely intended for the case when the nucleus N(A, Z+1) has energy less than the original nucleus N(A, Z). However, as we shall see below, reaction (9) is also admitted, especially for isotopes of small mass, for the case in which the nucleus N(A, Z+1) has energy bigger than the original nucleus N(A, Z). In this case the excitation energy of the photon must be evidently increased to supply this missing energy.

As we shall see below, the new nucleus N(Z+1) is generally unstable and often decays spontaneously also via beta decay

fnucl+N(A, Z)->N(A, Z+1)+b1−, Eq. (10a)

N(A, Z+1)->N(A, Z+2)+b2−, Eq. (10b)

and with the emission of an additional electron with energy of several additional MeV. In this case, one single resonating photon with about one MeV energy produces two beta electrons b1− and b2− with a much bigger energy.

A fundamental property of this invention experimentally verified and illustrated below is that the above stimulated beta decays exists also for stable isotopes and do not necessarily require that the selected isotope is unstable. As indicated earlier, this occurrence is due to the exchange forces of a nuclear structure, which establish the fact that neutrons decay even when the nucleus is stable, and merely transfer Rutherford's electron to another neutron. This feature is evidently important due to the general lack of harmful radiations (except the emission of electrons, which can be easily trapped with a thin metal shield).

Another important case occurs when the nucleus N(A, Z) of this invention is unstable, and naturally decays with a given meanlife. The original presence of radiations change the practical use of this invention into means for stimulating the decay of naturally unstable and radioactive nuclei. In this case one objective is to change the original nucleus with its original (generally long) meanlife into another nucleus with the same number of protons and electrons, yet with the shortest possible meanlife. Still in turn, this objective can be generally achieved by maximizing the number of protons in the final nucleus under a fixed value of A.

The latter objective is generally achieved via the use of a coherent beam of photons all with the needed excitation energy. In this case, nuclei are generally invested by more than one excitation photon, which may cause more than one stimulated beta decay. One beta decay may require more than one photon, as typical for large unstable nuclei. We reach in this way the multiple stimulated beta decay of a nucleus

2fnucl.+N(A, Z)->N(A, Z+2)+2b−. Eq. (11)

where the use of two resonating photons is generally sufficient for most practical applications since, for a given unstable nucleus N(A, Z), the resulting nucleus N(A, Z+2) is always unstable and with a dramatically smaller meanlife, thus achieving the desired objective.

The experimental verification of stimulated nuclear transmutation (9) has been successfully conducted by a group of experimentalists at the Nuclear Physics Department of the University of Thrace, Xhanti, Greece, comprising N. Tsagas, A. Mystakidis, G. Bakos, I. Seftelis, D. Koukoulis and S. Trassanidis, in the scientific paper “Experimental verification of Santilli's clean subnuclear hadronic energy, Hadronic Journal Vol. 19, page 87 (1999).

The experiment has been conducted in the following way as schematically illustrated in FIG. 5: 1) A commercially available, microcurie emitting disk of Eu(152, 63) was used as the source of excitation photons since said isotope emits photons with 1.3 MeV energy, thus being very close to the needed resonating value; 2) Said disk was placed next to a disk of natural Molybdenum as target; and 3) The energy of the electrons emitted by the Molybdenum disk was measured via a conventional scintillator enclosing said coupled disks in all directions. The equipment where then protected by an all encompassing external metal wall to shield the experiment from outside electrons.

Electrons originating from the Compton scattering of photons with peripheral atomic electrons can at most have the energy of 1 MeV, as well established in atomic physics. Therefore, the detection of electrons with energy over 2 MeV establishes their nuclear origin. Since the Eu(152, 63) source does not emit electrons, and the Molybdenum disk is stable, the only possible origin of the latter electrons is the stimulated decay of neutrons inside the Molybdenum disk.

A reproduction of the resulting measurements is presented in FIG. 6 in which; the upper diagram shows the background electron signal of the experimental set up as detected by the scintillator; the second diagram shows the same set up with the sole internal inclusion of the Europa source, in which case one should note the lack of appreciable differences since, as recalled earlier, the source Eu(152, 63) does not emit electrons; and the third diagram shows the signals received by the scintillator for the case when the joint disks of Europa and Molybdenum where placed in the inside. As one can see, the third diagram clearly shows the detection of electrons with energies ranging from 2.5 MeV to 3 MeV which, for the reasons indicated above, can only be of nuclear source, thus providing a clear experimental verification of our fundamental stimulated beta decay (9).

It should be indicated that the above experiment used a disk of commercially available Molybdenum which is a combination of rather numerous isotopes, while our stimulated beta decay (9) is expected to be applied, specifically, to one single isotope. An important task of this invention resolved below is therefore that of identifying which isotopes of the Molybdenum was actually responsible for the detected signals of FIG. 6.

Finally, it is evident that our basic process (9) needs additional independent experimental verifications in a variety of cases of direct practical value. Nevertheless, the above experiment has been here quoted because measurements can only be dismissed via counter-measured and positively they cannot be denied on grounds of personal views.

In summary, we have presented a new method for the synthesis of neutrons from protons and electrons comprising: means for said protons and electrons to have the threshold relative energy of 0.782 MeV; means for said protons and electrons to be in anti-parallel coupling; and means for forcing said protons and electrons in anti-parallel coupling to be at a mutual distance essentially of one Fermi.

We have also presented another new method for the stimulated decay of a peripheral neutron in a nucleus comprising in the absorption by said neutron of a photon with the resonating energy of 1.294 MeV plus corrections for nuclear binding energies and the conservation of the total energy, under the verification of the total angular momentum, parity and other nuclear laws.

We have finally set the foundations for an apparatus, to be described more appropriately below, for the stimulated beta decay of a natural isotope into another natural isotope the latter having the same number of nucleons of the former and one additional proton under the verification of the conservation of the angular momentum, parity, energy and other nuclear laws, comprising: a rod of said natural isotope; a source of a coherent beam of photons with the excitation energy of 1.294 MeV plus corrections due to the nuclear binding energy and the conservation of the energy, said coherent beam placed in such conditions to hit said rod of said natural isotope along its cylindrical symmetry axis; a metal shield for the capture of the highly energetic electrons emitted by said stimulated beta decay; a cooling system for said metal shield to utilize the produced heat via a heat exchanger; and means for utilizing the difference of potential between said metal shield and a ground for the production of DC electricity.

### DESCRIPTION OF THE DRAWINGS

FIG. 1 depicts a conceptual visualization of the synthesis of the neutron from a proton and an electron when in the core of a star;

FIG. 2 depicts the three attractive forces experienced by protons and electrons when in anti-parallel couplings at short distances;

FIGS. 3A and 3B depict experimental measurements confirming the laboratory synthesis of neutrons from protons and electrons;

FIGS. 4A and 4B depicts the spontaneous decay of the neutron when isolated in vacuum and when a member of a nuclear structure;

FIG. 5 depicts the experimental set up for the experimental verification of the stimulated beta decay;

FIG. 6 depicts experimental measurements confirming the stimulated beta decay via resonance photons; and

FIGS. 7A and 7B depicts a preferred embodiment for an equipment causing the stimulated beta decay of natural elements while recovering the produced heat and electricity.

### DESCRIPTION OF A PREFERRED EMBODIMENT FOR STIMULATED BETA DECAYS

After having identified a method for the stimulated beta decay of stable and unstable nuclei, the first need for the practical realization of a specific apparatus is the identification of nuclei admitting fundamental decay (9), because evidently not applicable to all natural isotopes. In fact, said stimulated decay is only possible for nuclei verifying various conditions which can be summarized as follows:

CONDITION 1: In stimulated decay (9), for any given isotope N(A, Z), the nucleus N(A, Z+1) must be a natural isotopes.

CONDITION 2: Stimulated decay (9) must verify the conservation of the angular momentum/parity here represented with the symbol Jp

Jp(f)+Jp[N(A, Z)]=Jp[N(A, Z+1)]+Jp(b−). Eq. (12)

CONDITION 3: Stimulated decay (9) must verify the conservation of the energy E, according to the rule

E(f)+E[N(A, Z)]=E[N(A, Z_{—}1)]+E(e)+E(v′), Eq. (13)

as well as verify the conservation of nuclear symmetries, superselection rules and other nuclear laws as needed by specific cases.

The same conditions apply for the multiple case (11). It is evident that, when all the above conditions are verified, the stimulated beta decay (9) is indeed possible. The features important for this disclosure are: (a) Even though not universally possible for all nuclei, there exist several natural isotopes verifying the above conditions, thus being candidates for the stimulated beta decay of this invention, in which case said isotopes are called “beta fuel”; (b) The above conditions do not restrict the nuclear mass, as a consequence of which the stimulated beta decay (9) is possible for small, medium and large nuclei; and (c) The above conditions do not restrict the original nuclei to be unstable, thus being applicable also to a selected number of light, natural, stable elements as shown below.

We are now equipped to present specific examples of beta fuels and their stimulated beta decay. We shall do so below by considering three separate classes of beta fuels and their applications. We shall then identify the construction details of a preferred embodiment for the industrial realization of stimulated beta decays.

Synthesis of Rare Isotopes

The selection of beta fuels can be done as follows. When searching for the basic stimulated decay (9), it is first recommendable to verify that, for one given nucleus N(A, Z), the final nucleus N(A, Z+1) exists as a natural isotope, otherwise other nuclei N(A, Z) verifying the fundamental Condition 1 above must be selected.

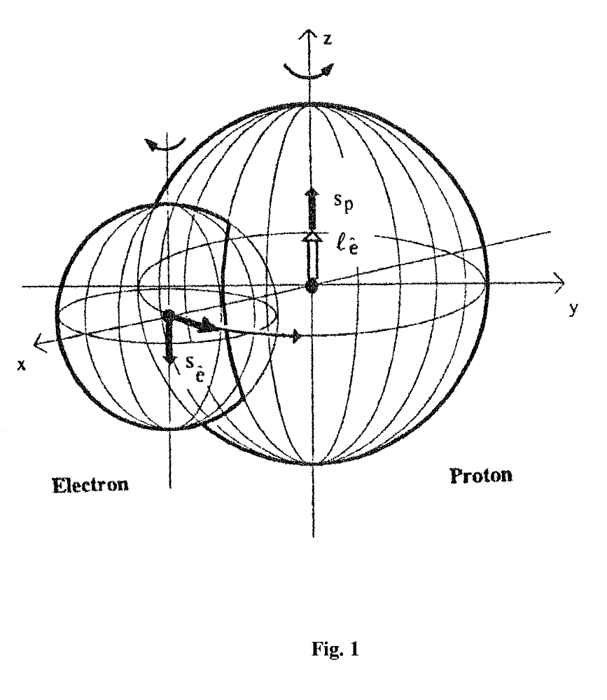

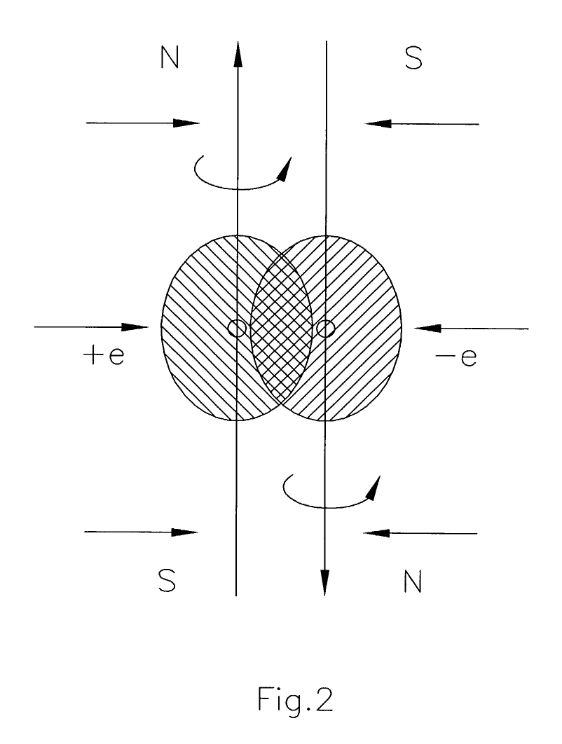

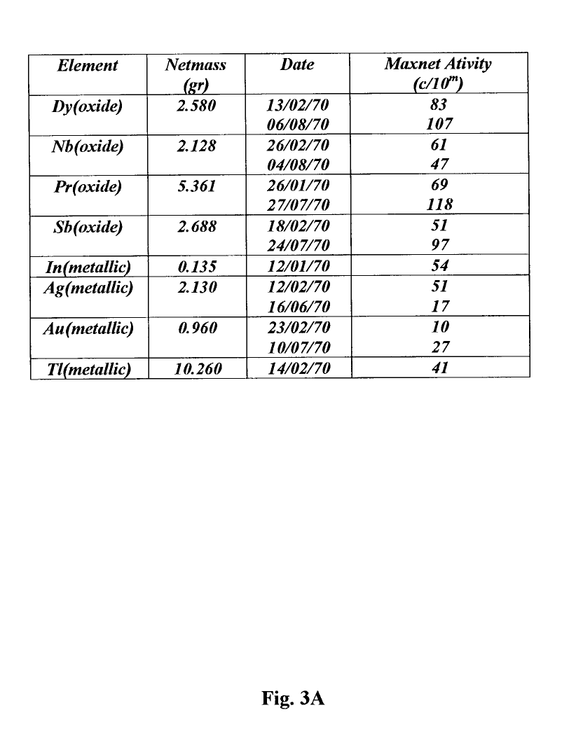

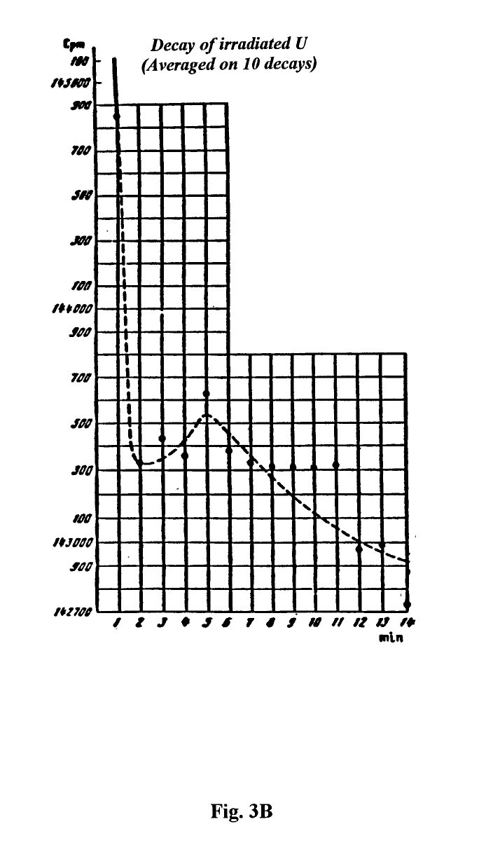

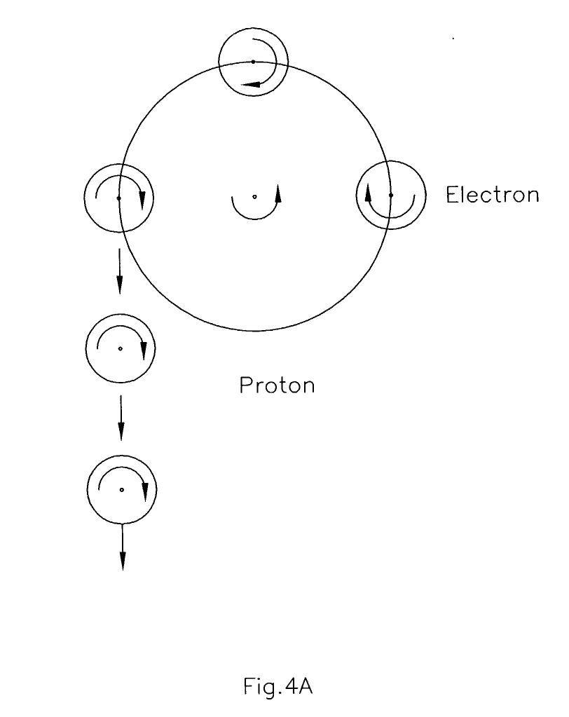

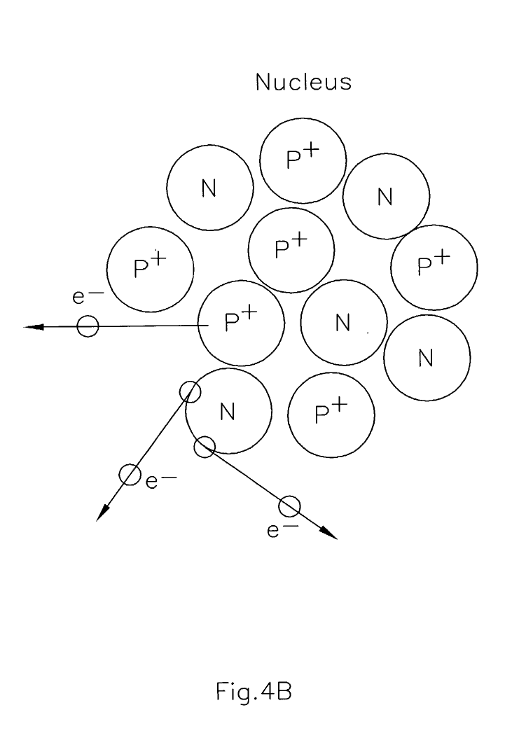

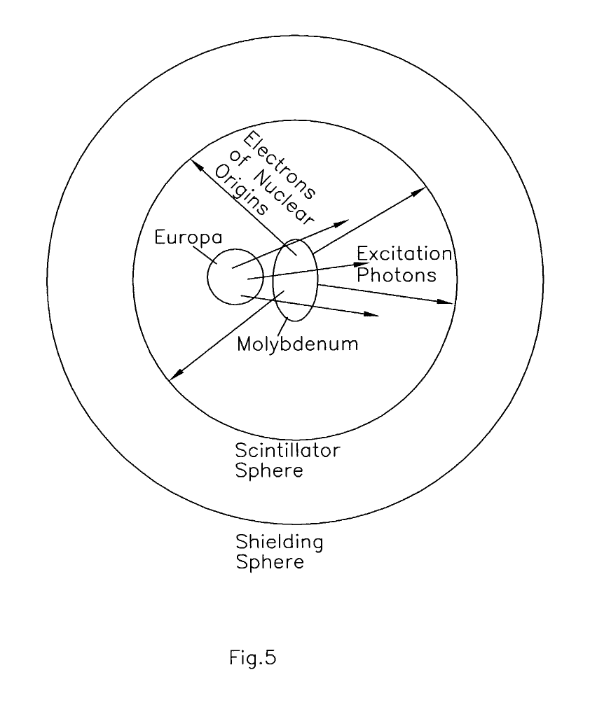

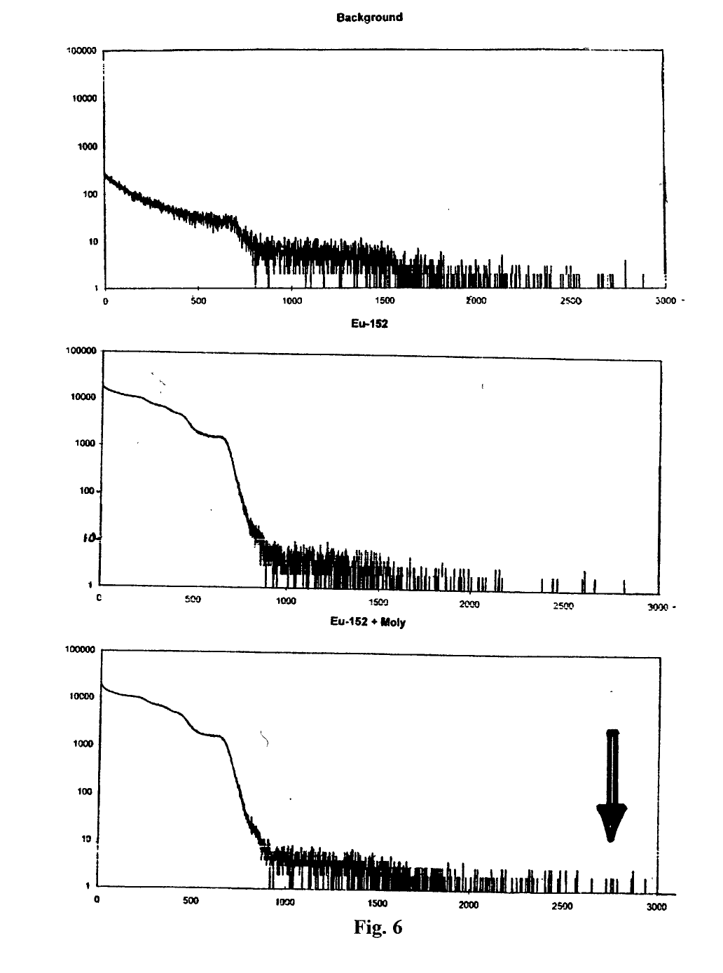

In regard to the conservation of angular momentum (Condition 2 above) note that, according to the decay of the neutron in the model of FIG. 4 (i.e., n->p+orbital motion+e), we have the following: (1) The spin of the neutron sn=½ is carried into that of the proton sp=½ due to the comparatively very small mass of the electron; (2) The electron is necessarily released with spin se=½ anti-parallel to that of the proton as a condition for their synthesis (FIG. 1); and (3) The orbital angular momentum of the electron se,orb=½ must be parallel to that of the proton since the latter traps the former in its rotational motion. As a result, we have the general rule

sn=½=sp−se+s−orb=½−½+½, sb=0. Eq. (14)

It then follows that the most natural mode for the stimulated beta decay is that in which the total angular momentum of the beta emission is null, sb=−½+½=0. Note that this condition is verified irrespective of whether we assume the angular momentum or the neutrino hypothesis.

The latter occurrence facilitates the selection of beta fuels. By recalling that the spin of the photon is 1, and that the photon is absorbed by the neutron, the best beta fuels occur when the isotopes N(A, Z) has spin 0, and the isotope N(A, Z+1) has spin 1. Note that the value 0 of the spin of the original isotope facilitates the construction of the embodiment since there is no need for any polarization of the photon or of the nucleus. The case when N(A, Z) has spin 1, and N(A, Z+1) has spin 0 is also acceptable, but it requires special polarization of the resonating photon and/or of the nucleus in such a way to couple with anti-parallel spins. Cases in which the original and final nuclei have the same spin are considered below for completeness, but only when such spins have the value ½.

The verification of parity is straightforward and generally occurs when the parities of the initial and final nuclei are the same, otherwise special treatments and embodiments are requested.

The verification of the total energy constitutes no problem because, in general, the final nucleus is at an energy level lower than that of the initial nucleus. In the event this condition is not verified, but all preceding conditions are, the conservation of the energy (Condition 3) is easily verified by suitably increasing the resonating energy of the photon. The conservation of nuclear symmetries and other nuclear laws can be generally done without major difficulties, again, when all preceding conditions are verified.

By using the above selection rules, the first example of stimulated beta decay for light nuclei is that of the Lithium

fnucl+Li(6, 3)->Be(6, 4)+b−. Eq. (15)

As one can see, Be(6, 4) exists and Condition 1 is verified. Li(6, 3) has spin/parity 1+ while Be(6.4) has the spin/parity 0+. Parity is then evidently preserved in the above reaction, although the preservation of the spin requires an embodiment achieving the anti-parallel coupling of the photon and of the original nucleus, which can be achieved, e.g., by polarizing via magnetic field Li(6, 3) in such a way to have angular momentum opposite that of the photon, in which case Condition 2 is verified since the spin of b− is 0.

For the verification of Condition 3, note that the atomic weight of the original Li(6, 3), 6.015 amu, is smaller than the atomic weight of the final Be(6, 4), 6.019 amu, in the amount of 0.004 amu=0.037 MeV. This energy must be supplied by the resonating photon to verify Condition 3. The verification of all other laws is straightforward.

We now remain with the precise identification of the resonating energy of the photon and its subharmonics. Recall that the basic resonating energy is 1.294 MeV, which must be corrected because of the nuclear binding energy as well as the energy missing for Condition 3. Recall that the binding energy of the Lithium is 31,994 MeV, namely, 5.332 MeV per nucleon, thus implying, according to rule (8), a correction to the basic resonating value of 5.332×0.511/938 MeV=0.003 MeV. By adding the missing energy and by substracting the correction for the binding energy we reach in this way the exact resonating energy value for reaction (15) of fnucl=1.294+0.037−0.003=1.328 MeV with evident subharmonics fnucl=0.664 MeV, 0.443 MeV, 0.332, etc. It should be recalled that these numerical values are very important for this invention because, as stressed earlier, resonating effect occurs only at sharp resonating values. Therefore, Reaction (15) should not be expected to have any appreciable value for photons with energy different than the those identified above.

As known from Nuclear Data, Be(6,4) is a very rare, permanently stable, light, and natural isotope. Therefore, reaction (15) constitutes a new process for the industrial production of rare isotopes via the stimulated beta decay.

Note finally that the beta electron is emitted with a maximal energy of 1.839 MeV, thus having an energy which is at least one million times bigger than that of an electron hitting a computer screen. Such energy can be tapped by capturing the beta electron via a metal shield, thus producing electricity plus heat, as explained in the preferred embodiment described below.

Other illustrations of this first group of applications is given by the so-called “mirror nuclei,” i.e., nuclei in which the total numbers of neutrons and protons are interchanged. When mirror nuclei verify all conditions above, they are fully acceptable beta fuels. One example of this class is given by

fnucl+C(13, 6)->N(13, 7)+b−. Eq. (16)

In this case, the final nucleus exists, but C(13, 6) and N(13, 7) have the same spin/parity (½)+. Despite that, the above reaction is still possible when the original nucleus is polarized in such a way to have spin opposite to that of the photon. In this case, the sum of the spin of the photon and of C(13, 6) does yield that of N(13, 7), since the spin of the beta emission is null, and Condition 2 is verified.

In reaction (16), the binding energy of C(13, 6) is 97.108 MeV corresponding to 7.470 MeV per nucleon which value, adjusted to the ratio 0.511/938=(electron mass)/(proton mass) yields the value 0.004 MeV. The resonance energy for C(13, 6) is then given by 1.294 MeV−0.004 MeV=1.290 MeV. In this case too the mass of the final nucleus N(13, 7) is bigger than that of the initial nucleus C(13, 6) by 0.0002 amu. This missing energy must be supplied by the resonating photon, although the correction is insignificant since it affects the fourth digit. The resonating energy for C(13, 6) is therefore given by 1.290 MeV. Its harmonics can be computed accordingly.

The final isotope B(13, 7) is also a very rare light, natural, and stable element as it was the case for Be(6, 4). Therefore, reaction (16) provides a second illustration for the use of stimulated beta decays of this invention to produce rare isotopes, while jointly producing electricity and heat, as illustrated in the apparatus described below.

A third example of this first group of application is given by the additional stimulated beta transition for mirror nuclei

fnucl+O(18, 8)->F(18, 9)+b− Eq. (17)

whose verification of all conditions above is omitted for brevity.

Production of Beta Energy.

A first example of this second group of applications is given by the isotope Zn(70, 30) which is a light, stable, natural element with the primary stimulated decay

fnucl+Zn(70, 30)->Ga(70, 31)+b−, Eq. (18)

In this case, Ga(70, 31) exists, Zn(70, 30) has spin 0+ and Ga(70, 31) gas spin 1+. As a result, all conditions for Zn(70, 30) to be a beta fuel are easily verified without any need for polarizations.

The binding energy of Zn(70, 30) is given by 611.081 MeV which corresponds to 8.130 MeV per nucleon. This yields a correction to the beta excitation energy according to Eq. (8) of 0.005 MeV, and results in the excitation energy of 1.289 MeV. In this case the resulting new nucleus is lighter than the original one with energy difference of 0.931 MeV. Therefore, no energy contribution is needed for the resonating photon, while the beta electron is emitted with the maximal energy of 2,220 versus the used energy of 1,289 MeV.

The element Ga(70, 30) is naturally unstable with a meanlife of 21.1 minutes and decays via beta-minus with energy release of 1.66 MeV according to the rule

Ga(70, 31)->Ge(70, 32)+b−. Eq. (19)

Therefore, the use of the original excitation energy of 1.289 MeV implies two stimulated beta decays with the emission of two electrons with a maximal total energy of 3.88 MeV (hereinafter also called “beta energy” to identify its origin) compared to the input energy of 1.289 MeV. These beta electrons can be captured with a metal shield to produce two forms of energy, electricity and heat, as illustrated below.

Note that the original beta fuel Zn(70, 30) is a light natural stable element, and so is the final nucleus Ge(70,32), while the emitted electrons or possible stray photons can be easily captured by a thin metal shield, as indicated earlier. Therefore, the production of energy via stimulated beta decays (18) and (19) does not emit any dangerous radiations and does not leave any dangerous waste.

Another illustration of this second group of applications is given by Mo(100, 42) which is also a light, natural and stable isotope admitting the stimulated beta decay

fnucl+Mo(100, 42)->Tc(100, 43)+b−. Eq. (20)

In this case, Tc(100,43) exists, Mo(100, 42) has spin/parity 0+ and Tc(100,43) has spin/parity 1+. As a consequence, all conditions for Mo(100, 42) to be a beta fuel are easily verified, again, without any need of polarizations.

The mass of Tc(100, 43) is greater than that of Mo(100, 42) by 0.0002 MeV which, after multiplication by 0.511/938 yield an insignificant correction to the basic excitation energy of 1.294 MeV. The beta electron is then emitted with the same maximal energy. The correction for the nuclear binding energy is 0.005 MeV and the exact value of the resonating energy is 1.289 MeV.

The element Tc(100, 43) is also unstable with a meanlife of 18 seconds and decays via beta-minus with energy ranging from 2.2 MeV to 3.38 MeV (depending on the final excitation state of the Ruthenium),

Tc(100, 43)->Ru(100, 44)+b−. Eq. (21)

As in the preceding illustrations, one excitation photon of 1.289 MeV produces two electrons with the total energy ranging from 3.5 to 4.7 MeV, which electrons can be captured with a metal shield to produce electricity and heat.

Again, the original beta fuel is a light, natural, stable element and so is the final nucleus. Therefore, the new form usable energy here introduced is clean in the sense that it does not release any harmful radiations and does not leave any harmful waste. This second example is preferred over the preceding one because the short meanlife of the secondary spontaneous beta decay is of only 18 seconds, thus permitting the apparatus described below to have a more rapid response.

An important aspect is whether other isotopes of the same element may also admit stimulated beta decays under the same photons. An inspection of Nuclear Data reveals that this is generally not the case. A first example is given by natural Zinc whose isotope Zn(70,30) is only 0.62% of the natural element. The remaining isotopes are Zn(64, 30) with 48.89%, Zn(66, 30) with 27.81%, Zn(67,30) with 4.11% and Zn(68, 30) with 18.67%. It is possible to prove that conservation laws permit the stimulated beta decay for Zn(70, 30) while the same stimulated decay is generally forbidden for all other isotopes. This point is important because it indicates that the use of commercial Zinc is dramatically less efficient than that of the sole use of its isotope Zn(70, 30).

Similarly, Molybdenum admits a large number of isotopes ranging from Mo(88, 42) to Mo(105, 42). Again, it is possible to show that basic decay (9) is generally forbidden for all isotopes, while being most favored for Mo(100, 42). This illustrates that in the experimental verification of the stimulated beta decay reviewed above (where the experimentalists used a disk of commercially available Molybdenum), the isotope which caused the detected nuclear electrons was Mo(100, 42). But the latter is contained in commercial Molybdenum in only 9.63% Therefore, the measurements of nuclear electrons can be dramatically increased via the use of the isotope Mo(100, 42), rather than commercial Molybdenum.

Recycling of Nuclear Waste

In this third group of applications, the objective is that of stimulating the decay of highly radioactive nucleus with long meanlife, or converting them into other, equally radioactive nuclei, although with a much smaller meanlife. As we shall see below, the apparatus for these processes is sufficiently small to be housed in a nuclear power plant with the recycling submerged within conventional nuclear pools, since its water will absorbed the radiations emitted by the decays.

The method and apparatus of this invention do permit the recycling of highly radioactive nuclear waste with long meanlives into radioactive nuclei of dramatically shorter meanlife, which decay into alfa particle and other fragments ultimately resulting in smaller non-radioactive nuclei. The fact that this recycling is possible by the nuclear power companies themselves in their plants is particularly important since it avoids the very expensive and dangerous transportation and storage of nuclear waste.

As indicated earlier, in this case it is most effective to use a coherent beam of photons with the needed resonating frequency, resulting in the multiple stimulated beta decays of type (11). As a first example, consider the nuclear waste U(238, 92) which has the very long meanlife of 4.51×109 years, and decays with the harmful emission of alpha particles and spontaneous fission (SF). The stimulated beta decay (11) implies the primary process

2fnucl+U(238, 92)->Np(238, 93)+b−, Eq. (22)

which however requires the joint absorption of two photon because the spin of U(238, 92) is 0+ while that of Np(238, 93) is 2+. The important point is that Np(238, 93) is also unstable, but with the dramatically reduced meanlife of 2.1 days, during which it can be left submerged within nuclear pools. This illustrates the type of recycling of radioactive waste permitted by this invention.

Medical and Scientific Applications

The stimulated beta decay of this invention also permits additional, basically novel applications in medicine, because it permit the transmutation of cancerous cells the body cannot dispose of into other cells which can be eliminated by our immune system, as it is the case when the isotopes of cancerous cells are transformed via stimulated beta decays into different isotopes.

The scientific applications of this invention are virtually endless and include advances in: nuclear physics (e.g., a deeper understanding of the nuclear force), particle physics (e.g., new understanding of the structure of strongly interacting particles), theoretical biology (e.g., a deeper understanding of the structure and production of proteins as a pre-requisite for their artificial production), superconductivity (e.g., to improve the prediction of bigger temperatures), chemistry (e.g., to reach a better understanding of the valence bond) and other fields.

Preferred Embodiment

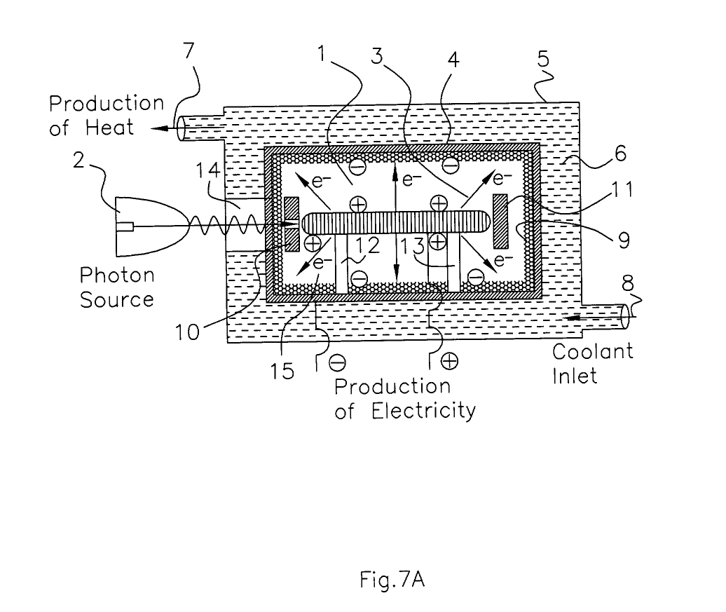

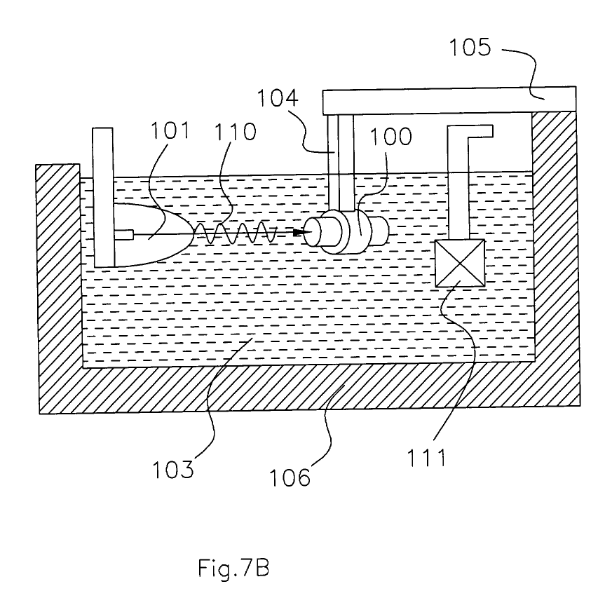

The preferred embodiment of this invention is illustrated in FIG. 7A, and comprises the beta fuel 1 (that is, a natural isotope admitting the stimulated beta decay as identified above) which beta fuel, without loss of generality, is here assumed to have the shape of a thin rod of 1/16″ in diameter and the length of 1″ supported by insulating supports 12 and 13. The needed resonating photons per each beta fuel are produced by equipment 2, which is commercially available, such as an electron-positron synchrotron, and, as such, it is herein assumed as known and not identified in construction details. Said beta source 2 is selected to create a coherent beam of photons with the needed resonating energy at the rate of 108 photons per second and with a direction aligned along the symmetry axis of the beta fuel rod.

When the beta fuel rod is hit by resonating photons, it experiences the stimulated beta decay illustrated above and emits highly energetic electron 3. The latter can be trapped high tensil stress with metal shield 4 of ½″ in thickness suitable to support an internal vacuum with the internal surface coated with metal sponge 9 to avoid scattering and having the parallelopipidal internal dimension of 1′×1′×1′. Said metal shield entirely encloses the beta fuel rod places in its center via supports 12 and 13, and has a window 14 made of material transparent to said resonating photons. A high vacuum is then pulled our of the interior volume 15 via commercially available vacuum pumps not shown in FIG. 7A for simplicity, so that the emitted nuclear electrons encounter no resistance in their flight toward the metal shield 4.

As a result of the high energy of the captured electrons, shield 4 acquires considerable heat in the range of 106 Joules/hour. This heat is utilized via a cooling system comprising the external metal casing 5 of ¼″ in thickness which has the same shape of metal shield 4, yet it is such to leave 3″ of interspace all around and suitable to flow a coolant 6 such as antifreeze with inlet 8 and outlet 7. Coolant 6 is then transferred to a heat exchanger which is omitted from FIG. 7A because commercially available. In this way, the stimulated beta decay of this invention provides a first source of usable clean energy in the form of heat. It is understood in the trade by those skilled in the art how to direct the flow of coolant using commercially available components such as valves, pumps, radiators, steam generators and the like so as to productively use the generated heat and as such need not be more fully described herein.

Metal shield 4 evidently acquires a large negative charge which can be utilized by connecting said shield 4 to a suitable ground, or by selecting beta fuels to be conductors, such as Zn(70, 3) and Mo(100, 42). As a consequence, the stimulated beta decay of this invention causes a difference of potential, which can be utilized to produce a DC electric current. In this way, the preferred embodiment of this invention constitutes a genuine nuclear battery for the production of DC electricity, thus providing a second source of usable clean energy in the form of electricity.

In the event the rod of beta fuel needs polarization of the spin direction, the preferred embodiment herein considered includes the addition of a magnetic field with end polarities 10 and 11 and magnetic lines along the symmetry axis of the beta fuel rod, with polarity 10 on the side of the photon beam having an opening for the passage of the latter. Said magnetic field can be realized in a variety of ways, such as via permanent magnets, electromagnets, etc., which, being commercially available, are not discussed herein in constructive details.

The production of electricity initiates immediately at the time of the activation of the resonance photon beam, although reaches a peak at the time of initiation of secondary beta decays. Following the disconnection of the resonating photon beams, the production of electricity is halted at the exhaustion of said secondary beta decays.

After the use of said beta fuel rod for a sufficient period of time expected to be of the order of one month, the direction of the same rod can be reversed for one additional month of use. When the production of rare isotopes is requested, the beta fuel rod can be removed following inversion and use until a major reduction of the produced electricity occurs.

For the case of highly radioactive nuclear waste, a preferred embodiment of this invention is illustrated in FIG. 7B and essentially consists of conventional nuclear waste pellets 100 submerged within the water 103 of a conventional nuclear pool 106 or equivalent, and kept by a mechanical arm 104 with operation and support 105 outside said pool. Without any loss of generality, in the preferred embodiment the source 101 of a coherent neutron beam is stationary and mechanical arm 104 keeps the nuclear waste pellet 100 in an axial alignment in front of the resonating photon beam 110 for three to five days, then inverts the orientation of said pellet for the same duration, and uses other orientations as needed.

Once the highly radioactive nuclear waste pellet with long meanlife has been exposed to the beam 110 of resonating photon it is transformed into other highly radioactive elements but with much shorter meanlife. The latter then disintegrates with all debries being trapped inside the water 103. The recycling of said pellet is ended when the submerged detector 111 detects no additional radiation.

What is claimed is:

1. A method for the synthesis of neutrons from protons and electrons comprising:
means for said protons and electrons to have a threshold relative energy of about 0.80 MeV;
means for said protons and electrons to be in planar anti-parallel coupling; and
means for forcing said protons and electrons in said planar anti-parallel coupling to be at a mutual distance essentially of one Fermi.

2. The method according to claim 1, wherein said threshold energy is achieved via difference in speeds of protons and electrons.

3. The method according to claim 1, wherein said planar anti-parallel spins are achieved via the use of a magnetic field.

4. The method according to claim 1, wherein said mutual distance of protons and electrons is achieved via pressure.

5. A method for the stimulated decay of a peripheral neutron in a nucleus comprising the absorption by said neutron of a photon with a resonating energy of about 1.294 MeV plus corrections due to the nuclear binding energies and the conservation of total energy, wherein the conservation of total angular momentum and parity are satisfied.

6. The method according to claim 5, further comprising a source of said photon, said source creating a coherent beam of said resonance photons.

7. The method according to claim 5, wherein said nucleus characterizes a conductor.

8. The method according to claim 5, wherein a nucleus resulting from said stimulated beta decay is a rare natural element.

9. The method according to claim 5, wherein a nucleus structure resulting from said stimulated beta decay is a highly radioactive nuclear waste.

10. Apparatus for the stimulated beta decay of a natural isotope into another natural isotope, the latter having the same number of nucleons of the former and one additional proton, wherein the conservation of total energy, angular momentum and parity are satisfied, comprising:
a rod of said natural isotope;
means for creating a coherent beam of photons at a resonating energy and at a direction aligned such that the beam of photons hits the rod of said natural isotope along its symmetry axis, the desired resonating energy including corrections due to the effects of other energies, including, but not limited to, nuclear binding energies and total energy;
the rod of the natural isotope being essentially contained in an interior chamber of a double-walled case, the interior chamber being lined with a metal shield for the capture of the highly energetic electrons emitted by said stimulated beta decay;
means for cooling said metal shield, said means including an outer chamber essentially surrounding said interior chamber and metal shield, said outer chamber having a coolant therein in communication with heat exchanger means for productive use of heat generated in the metal shield which is transferred to the coolant; and
means for utilizing the difference of potential between said metal shield and a ground for the production of DC electricity.

11. The apparatus according to claim 10, wherein said resonating energy is about 1.294 MeV plus corrections due to the nuclear binding energies and the conservation of total energy, wherein the conservation of total angular momentum and parity are satisfied.

12. The apparatus according to claim 10, wherein said resonating energy is a subharmonic of about 1.294 MeV plus corrections due to the nuclear binding energies and the conservation of total energy, wherein the conservation of total angular momentum and parity are satisfied.

13. The apparatus according to claim 10, wherein said resonating energy is about 0.511 MeV plus corrections due to the nuclear binding energies and the conservation of total energy, wherein the conservation of total angular momentum and parity are satisfied.

14. The apparatus according to claim 10, wherein said resonating energy is a subharmonic of about 0.511 MeV plus corrections due to the nuclear binding energies and the conservation of total energy, wherein the conservation of total angular momentum and parity are satisfied.

15. The apparatus according to claim 10, wherein the natural isotope resulting from said stimulated beta decay is rare.

16. The apparatus according to claim 10, wherein the natural isotope resulting from said stimulated beta decay is a highly radioactive nuclear waste.

17. The apparatus according to claim 10, wherein said rod of the natural isotope is a conductor.

18. The apparatus according to claim 17, wherein there is a difference of potential between said metal shield and said rod of the conducting natural element.

19. Apparatus for the stimulated beta decay of radioactive waste comprising:
nuclear waste submerged in a liquid;
means for creating a coherent beam of photons at a resonating energy and at a direction aligned such that said beam of photons hits the nuclear waste, the desired resonating energy including corrections due to the effects of other energies, including, but not limited to, nuclear binding energies and total energy; and
means for rotating said nuclear waste so as to be completely exposed to said beam,
wherein when a highly radioactive nuclear waste with a relatively long meanlife is exposed to said beam for a predetermined time, the highly radioactive nuclear waste is transformed into other highly radioactive elements with shorter meanlife.

20. The apparatus according to claim 19, wherein the nuclear waste is in the form of pellets.

21. The apparatus according to claim 19, wherein said liquid is water.

22. The apparatus according to claim 19, further comprising a radioactivity detector for monitoring radiation levels, said detector being mounted near said radioactive waste.

23. The apparatus according to claim 19, wherein said resonating energy is about 1.294 MeV plus corrections due to the nuclear binding energies and the conservation of total energy, wherein the conservation of total angular momentum and parity are satisfied.

24. The apparatus according to claim 19, wherein said resonating energy is a subharmonic of about 1.294 MeV plus corrections due to the nuclear binding energies and the conservation of total energy, wherein the conservation of total angular momentum and parity are satisfied.

25. The apparatus according to claim 19, wherein said resonating energy is about 0.511 MeV plus corrections due to the nuclear binding energies and the conservation of total energy, wherein the conservation of total angular momentum and parity are satisfied.

26. The apparatus according to claim 19, wherein said resonating energy is a subharmonic of about 0.511 MeV plus corrections due to the nuclear binding energies and the conservation of total energy, wherein the conservation of total angular momentum and parity are satisfied.
